(19) United States
(12) Patent Application Publication
(10) Pub. No.: US 2026/0350558 A1
(43) Pub. Date: Nov. 5, 2026

(54) AUTOMATED CLEARING HOUSE (ACH) MANAGEMENT SYSTEM USING ARTIFICIAL INTELLIGENCE (AI) VERIFICATION

(71) Applicant: Truist Bank, Charlotte, NC (US)

(72) Inventor: Prasad Jahagirdar, Charlotte, NC (US)

(73) Assignee: Truist Bank, Charlotte, NC (US)

(21) Appl. No.: 19/198,524

(22) Filed: May 5, 2025

(51) Int. Cl. G06Q 20/02

(52) U.S. Cl. CPC G06Q 20/023

(57) ABSTRACT

A computer-implemented method includes receiving, by an enterprise server from a client device, an ACH authentication request for preparing a plurality of electronic ACH transactions. The computer-implemented method also includes acquiring, by the enterprise server, one or more ACH recipient data files having a predefined file format, each ACH recipient data file corresponding to at least one ACH recipient account related to the electronic ACH transactions. Further, the computer-implemented method includes deploying, by the enterprise server, a trained generative artificial intelligence (GenAI) model configured to verify accuracy of data within the ACH recipient data files based on verification criteria and generate details for the electronic ACH transactions. Also, the computer-implemented method includes processing, by the enterprise server, each of the electronic ACH transactions for which the accuracy of the data within a corresponding ACH recipient data file is affirmatively verified.

### TECHNICAL FIELD

The present disclosure relates to data management systems, and more specifically, the present disclosure relates to a data management system for managing automated clearing house (ACH) transactions using artificial intelligence (AI) verification.

### BACKGROUND

Conventional ACH transaction processing systems face significant inefficiencies, particularly when transferring funds from an ACH originator account to multiple recipient accounts. These inefficiencies manifest in increased processing times and costs, leading to delays in fund transfers and reducing customer satisfaction. Existing solutions typically require manual intervention and lack a streamlined, automated process for handling multiple recipient accounts in a single transaction.

ACH transaction processing systems typically involve the storage and comparison of financial information to ensure compliance with ACH standards. These systems may include mechanisms for pausing transactions, presenting them to clients for decision-making, and managing online authorizations. Additionally, authentication systems are employed to verify the legitimacy of ACH transactions. These systems typically send challenges to client devices and evaluate responses based on account data. These systems also incorporate risk-based decisioning (RBD) to evaluate transactions and may include funds indicators to ensure sufficient funds are available for the transaction.

Despite these measures, conventional ACH transaction processing systems still demand manual intervention. For example, when transferring funds from a single originator account to multiple recipient accounts, each transaction must be individually processed, leading to increased processing times and administrative overhead. This inefficiency is further exacerbated by the need for human review and decision making for transactions that violate certain rules or criteria. Consequently, businesses and financial institutions experience delays in fund transfers, which may negatively impact customer satisfaction and operational efficiency.

### SUMMARY

An enterprise server is configured to concurrently execute ACH transactions from an ACH originating account to a plurality of ACH recipient accounts in a single processing run based on generative AI verification of one or more recipient data files detailing information about the recipient accounts, in one embodiment.

According to an embodiment, a computer-implemented method for managing ACH transaction processing is described. The computer-implemented method includes receiving, by an enterprise server from a client device, an ACH authentication request for preparing a plurality of electronic ACH transactions. The computer-implemented method also includes acquiring, by the enterprise server, one or more ACH recipient data files having a predefined file format, each ACH recipient data file corresponding to at least one ACH recipient account related to one or more of the plurality of electronic ACH transactions. Further, the computer-implemented method includes deploying, by the enterprise server, a trained generative artificial intelligence (GenAI) model configured to verify accuracy of data within the one or more ACH recipient data files based on one or more verification criteria and generate details for the plurality of electronic ACH transactions. Also, the computer-implemented method includes processing, by the enterprise server, each of the plurality of electronic ACH transactions for which the accuracy of the data within a corresponding one of the ACH recipient data files is affirmatively verified.

In another embodiment, a system for managing ACH transaction processing is described. The system includes at least one processor and a non-transitory computer-readable medium having instructions embodied therewith that, when executed by the at least one processor, cause the at least one processor to perform operations. The operations include receiving, by an enterprise server from a client device, an ACH authentication request for preparing a plurality of electronic ACH transactions. The operations also include acquiring, by the enterprise server, one or more ACH recipient data files having a predefined file format, each ACH recipient data file corresponding to at least one ACH recipient account related to one or more of the plurality of electronic ACH transactions. Further, the operations include deploying, by the enterprise server, a trained GenAI model configured to verify accuracy of data within the one or more ACH recipient data files based on one or more verification criteria and generate details for the plurality of electronic ACH transactions. Also, the operations include processing, by the enterprise server, each of the plurality of electronic ACH transactions for which the accuracy of the data within a corresponding one of the ACH recipient data files is affirmatively verified.

In yet another embodiment, a computer program product for managing ACH transaction processing is described. The computer program product includes a non-transitory computer-readable medium having instructions embodied therewith that, when executed by at least one processor, cause the at least one processor to perform operations. The operations include receiving, by an enterprise server from a client device, an ACH authentication request for preparing a plurality of electronic ACH transactions. The operations also include acquiring, by the enterprise server, one or more ACH recipient data files having a predefined file format, each ACH recipient data file corresponding to at least one ACH recipient account related to one or more of the plurality of electronic ACH transactions. Further, the operations include deploying, by the enterprise server, a trained GenAI model configured to verify accuracy of data within the one or more ACH recipient data files based on one or more verification criteria and generate details for the plurality of electronic ACH transactions. Also, the operations include processing, by the enterprise server, each of the plurality of electronic ACH transactions for which the accuracy of the data within a corresponding one of the ACH recipient data files is affirmatively verified.

### BRIEF DESCRIPTION OF THE DRAWINGS

The various advantages of the exemplary embodiments will become apparent to one skilled in the art by reading the following specification and appended claims, and by referencing the following drawings.

FIG. 1 shows training of a machine learning model in accordance with one or more embodiments.

FIG. 2 illustrates a flow chart of a computer-implemented method for managing ACH transaction processing, according to one embodiment.

FIG. 3 illustrates a flow chart of a computer-implemented method for acquiring ACH recipient data file(s), according to one embodiment.

FIG. 4 illustrates a flow chart of a computer-implemented method for deploying a GenAI model, according to one embodiment.

FIG. 5 illustrates a flow chart of a computer-implemented method for iteratively training a GenAI model, according to one embodiment.

FIG. 6 shows a block diagram of an example computing system that may implement the features and processes of any of FIGS. 1-5.

FIG. 7 illustrates an example network architecture that may implement the features and processes of any of FIGS. 1-5.

### DETAILED DESCRIPTION

In the following descriptions, for the purposes of explanation, numerous specific details are set forth to provide a thorough understanding to the reader but are not meant to limit the present disclosure in any way. One or more embodiments may be practiced without these specific details. Features described in one embodiment may be used in combination with features described in a different embodiment in various possible combinations and permutations. In some examples, well-known structures and devices are described with reference to block diagrams to avoid unnecessarily obscuring the present disclosure.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

### DEFINITIONS

Several non-limiting example definitions are provided below for clarity and illustrative purposes in reading these descriptions and should not be construed to limit the scope of the one or more embodiments disclosed herein in any manner. It is also contemplated that these and other terms may also be defined by their common uses in the context of these descriptions.

The term “about” as used herein indicates the value preceded by the term “about,” along with any values reasonably close to the value preceded by the term “about,” as would be understood by one of skill in the art. When not indicated otherwise, the term “about” denotes the value preceded by the term “about” ±10% of the value. For example, “about 10” indicates all values from and including 9.0 to 11.0.

As used herein, “application” may relate to software used on a computer (usually by a client and/or client device and can be applications that are targeted or supported by specific classes of machine, such as a mobile application, desktop application, tablet application, and/or enterprise application (e.g., client device application(s) on a client device). Applications may be separated into individual applications which reside on a client device (e.g., virtual private network (VPN) client, Microsoft ® PowerPoint®, Microsoft® Excel®, etc.) and cloud applications which may reside in the cloud (e.g., Google® Gmail®, GitHub®). Cloud applications may correspond to applications on the client device or may be multi-user applications, such as social media applications (e.g., Facebook®, Linkedin®, etc.).

As used herein, “artificial intelligence” or “AI” may relate to one or more computer systems operable to perform one or more tasks that normally require human intelligence and learning capabilities, such as visual perception, speech recognition, decision-making, and translation between languages.

As used herein, “dynamically” may relate to events or actions that can be caused, triggered, or otherwise occur without human intervention.

As used herein, “machine learning” may relate to an application of AI that provides computer systems the ability to automatically learn and improve from data and experience without being explicitly programmed.

As used herein, “computer” may relate to a single computer or to a system of interacting computers. A computer is a combination of a hardware system, a software operating system and perhaps one or more software application programs. Examples of a computer include, without limitation, a personal computer (PC), a desktop computer, a server, a mainframe, an appliance device, a laptop computer, a smartphone, a satellite phone, a tablet computer, etc.

As used herein, “client device” may relate to any system, apparatus, and/or device associated with a user (who may be a client, customer, administrator, or some other person accessing the device), including personal computers, laptops, tablets, and/or mobile smartphones.

As used herein, “modules” may relate to software modules (e.g., code embodied on a machine-readable medium or in a transmission signal), hardware modules, or a combination thereof. Certain embodiments are described herein as including logic or a number of components, modules, or mechanisms.

As used herein, a “software module” (or just “software”) may relate to code embodied on a computer-readable medium or in a transmission signal for performing or causing performance of one or more tasks by one or more processors. Software may relate to a set of instructions and associated documentation that direct one or more processors or a computer what to do or how to perform a task. Software may include any different types of software programs executable on a computer, such as applications and/or the operating system. A software application may be written in substantially any suitable programming language, which would be easily selectable by one of ordinary skill in the art. The programming language chosen should be compatible with the computer by which the software application is to be executed and, in particular, with the operating system of that computer. Examples of suitable programming languages include, without limitation, Object Pascal, C, C++, Common Gateway Interface (CGI), Java, Java Scripts, etc. Further, the functions of some embodiments, when described as a series of steps for a method, could be implemented as a series of software instructions for being operated by a processor, such that the embodiments could be implemented as software, hardware, or a combination thereof.

A “hardware module” (or just “hardware”) as used herein may relate to a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field Programmable Gate array (FPGA) or an application specific integrated circuit (ASIC).

A hardware module may also include programmable logic or circuitry that is temporarily configured by software to perform certain operations. A hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module.

Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access.

As used herein, “network” or “networks” may relate to any combination of electronic communication networks, including, without limitation, the Internet, a local area network (LAN), a wide area network (WAN), a wireless network, and a cellular network, e.g., General Packet Radio Service (GPRS), Long Term Evolution (LTE), 4G, 5G, etc.

As used herein, “processes” or “methods” are presented in terms of methods or symbolic representations of operations performed on data stored as bits or binary digital signals within a computer-readable memory (e.g., a machine memory). These methods or symbolic representations are examples of techniques used by those of ordinary skill in the art of data processing to convey the substance of their work to others skilled in the art. As used herein, a “process” is a self-consistent sequence of operations or similar processing leading to a desired result. In this context, processes and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information.

As used herein, “processor-implemented module” may relate to a hardware module implemented using one or more processors. The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein.

As used herein, “server” may relate to a server computer or group of computers that acts to provide a service for a certain function or access to a network resource. In various examples, a server may be a physical server, a hosted server in a virtual environment, or software code running on a hardware platform.

As used herein, “service” or “application” may relate to software executable by one or more processors (e.g., an online server or set of servers) to perform one or more tasks and may refer to locally executed software (e.g., operating system, web browser, etc.) or software that is remotely accessible (e.g., a web site, web application, cloud application, etc.).

As used herein, “sensor” may relate to any device, component and/or system that is configured to perform one or more of detecting, determining, assessing, monitoring, measuring, quantifying, and sensing operations.

As used herein, “real-time” may relate to a level of processing responsiveness that a user, module, or system senses as sufficiently immediate for a particular process or determination to be made, or that enables the processor to keep up with an external process.

As used herein, “user” may relate to a consumer, customer, administrator, operator, machine entity, and/or requesting party, and may be human or machine in various approaches.

### MACHINE LEARNING

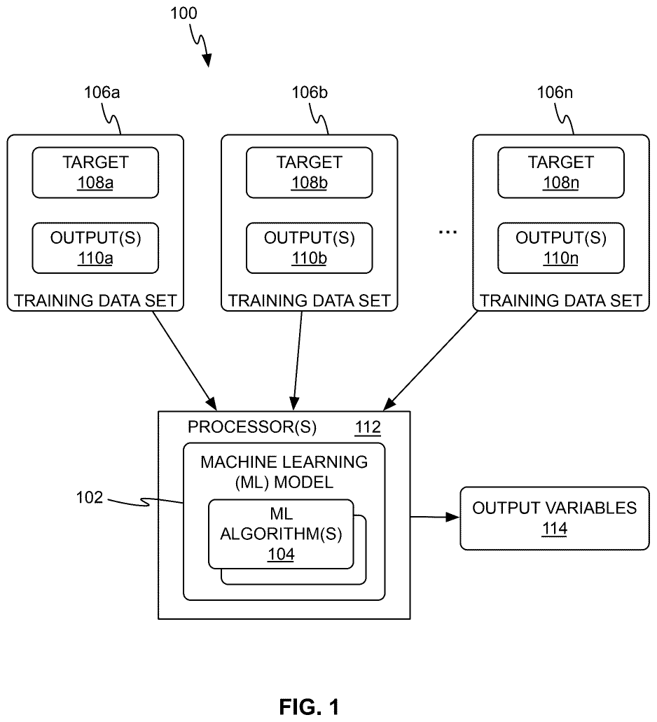

FIG. 1 shows a system 100 for training a machine learning (ML) model 102 in accordance with one or more embodiments. An ML algorithm 104 is an algorithm that can iteratively learn a target model to provide a desired output when provided with select input types. In particular, an ML algorithm 104 is configured to generate and/or train ML model 102 using sets of training data 106 to select endpoints for obtaining desired outputs, and curating these outputs to present in a data management interface or some other user interface mechanism (visual, audible, etc.).

The ML algorithm 104 may iteratively learn a target model that best maps a set of input variables to one or more output variables using training data sets 106 (e.g., training data set 106a, training data set 106b, . . . , training data set 106n). The training data sets 106 each include a target condition, circumstance, or stimulus 108, desired outputs 110 based on the specific details of the associated target condition, circumstance, or stimulus, and associated labels to enable mapping in the learning phase. The training data sets 106 are associated with input variables for the target model. The associated labels are associated with the output variable(s) of the target model. The ML algorithm 104 generates a target model such that the target model best fits the training data sets 106 to the associated labels. Additionally, or alternatively, the ML algorithm 104 may generate a target model so that applying the training data sets 106 produces a maximum number of results determined by the target model to match the associated labels. Different target models may be generated based on different ML algorithms 104 and/or different training data sets 106.

The ML algorithm 104 may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering, in various different embodiments.

The training data sets 106 may be updated based on feedback from execution of the current target model and/or ML model 102, e.g., feedback on the accuracy of the current target model, user response when presented with the one or more output variables, etc. Updated training data sets 106 are introduced to the ML algorithm 104, which in turn updates the target model used in ML model 102.

Once the ML model 102 is trained, processor(s) 112 are configured to apply the ML model 102 to provide output variables 114 for which training data sets 106 were provided during training. Should a new or different type of stimulus or input be encountered, one or more additional training data sets 106 may be created that describe this new information and the ML model 102 may be trained using this updated training data set so that it can recognize this new stimulus or input in the future and provide appropriate response(s).

### MANAGING ACH TRANSACTIONS

Conventional ACH transaction processing systems often lack the capability to handle large volumes of transactions in a single batch process, thereby increasing the likelihood of errors and inconsistencies. The need for manual intervention in these processes not only increases the time required to complete transactions, but also introduces additional costs associated with labor and potential errors introduced during the manual intervention. These inefficiencies should be eliminated or reduced for a more streamlined and automated approach to ACH transaction processing, particularly for situations involving multiple recipient accounts to efficiently manage large volumes of transactions with minimal manual intervention.

Described herein, according to multiple embodiments, are systems, methods, and computer program products that manage ACH transaction processing capable of handling large volumes of transactions in a single batch process, thereby reducing the probability of mistakes and discrepancies that arise from manual intervention during these processes.

### EXAMPLE PROCESSES

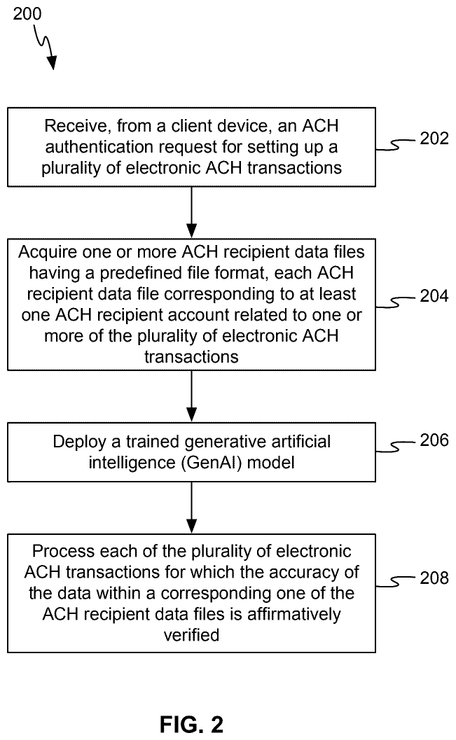

Referring now to FIG. 2, a flow chart of a computer-implemented method 200 for managing ACH transaction processing is shown according to one embodiment. Of course, more or less operations than those specifically described in FIG. 2 may be included in computer-implemented method 200, as would be understood by one of skill in the art upon reading the present descriptions.

Each of the operations of computer-implemented method 200 may be performed by any suitable component of the operating environment. For example, in various embodiments, computer-implemented method 200 may be partially or entirely performed by a cloud server, a portable computer, a handheld or wearable computer, a mobile device, one or more hardware processors of a computing device, an application operating on a computing device, a server device, a host device, a processing circuit having one or more processors therein, or some other device having one or more processors therein. The processing circuit, e.g., processor(s), chip(s), and/or module(s) implemented in hardware and/or software, and preferably having at least one hardware component, may be utilized in any device to perform one or more operations of computer-implemented method 200. Illustrative processors include, but are not limited to, a CPU, an ASIC, a FPGA, etc., combinations thereof, or any other suitable computing device known in the art.

In one embodiment, computer-implemented method 200 may be performed by an enterprise server that is configured to manage one or more accounts, particularly those capable of having ACH transactions executed therefor. Although computer-implemented method 200 is described as being performed by an enterprise server, any suitable computing device may be used, alone or in combination with other electronic devices, to perform computer-implemented method 200 in various embodiments.

In operation 202, the enterprise server receives, from a client device, an ACH authentication request for preparing a plurality of electronic ACH transactions. The ACH authentication request may be sent directly to the enterprise server, may be acquired by the enterprise server from the client device, or may be snooped by the enterprise server based on another communication from the client device that capable of being viewed and in a format that is understandable to the enterprise server.

The client device may be any type of computing device known to those of skill in the art, such as a laptop computer, desktop computer, tablet computer, smartphone, etc. The client device may be registered to communicate with the enterprise server in one embodiment, prior to sending the request to the enterprise server. In another approach, the enterprise server receiving the ACH authentication request may trigger a registration process for the client device.

The enterprise server is configured to manage financial accounts for various users and client devices, as well as open, close, and modify accounts that are set up (e.g., through a platform) by a financial institute associated with such accounts (e.g., bank, brokerage, investment firm, etc.). By “manage,” what is meant is that the enterprise server has access to the account and is configured to at least perform external and/or internal transactions into, out of, or through the managed accounts.

In an embodiment, prior to acquiring the one or more ACH recipient data files, the enterprise server may acquire ACH authentication credentials of the client device. The ACH authentication credentials may comprise a set or combination of information and/or details that may be used to verify that the client device is authorized to conduct ACH transactions for at least one ACH originator account managed by the enterprise server.

In one example, the ACH authentication credentials comprise an account holder's name, a routing number, and an account number. Although the term “routing number” is used herein in conjunction with financial institutes, in one or more embodiments, other codes may be used to designate a particular business or entity, such as bank codes, transit numbers, unique business identifier (UBI), unique entity identifier (UEI), business number (BN), taxpayer identification number (TIN), employer identification number (EIN), etc. These other codes may be used in place of or in addition to a routing number, in various approaches.

Based on the ACH authentication credentials, the enterprise server may verify the legitimacy and ownership of the bank account involved for the requested ACH transactions. The enterprise server may, in some embodiments, verify the identity of the user requesting the ACH transaction(s) and whether a signed authorization form has been received. In this embodiment, if no such form has been received, the enterprise server may provide such an authorization form to the client device for the user to sign and return prior to continuing method 200.

In other words, responsive to acquiring the ACH authentication credentials, the enterprise server may, based on the ACH authentication credentials: 1) authenticate that the client device is authorized to conduct ACH transactions for an ACH originator account managed by the enterprise server, 2) determine that the client device is not authorized and/or registered to conduct ACH transactions for any accounts managed by the enterprise server. In either scenario, the enterprise server may take additional steps to verify or validate the identity of the user or client device, or to allow for such verification to take place, as described herein in various embodiments and/or as would be known to those of skill in the relevant art.

In operation 204, the enterprise server acquires one or more ACH recipient data files. Each of the ACH recipient data files have a predefined file format that is recognizable by the enterprise server. In several embodiments, the predefined file format may be one of the following file types: .pdf, .doc, .docx, .csv, .xls, .xlsx, etc. Of course, other file types may also be used, in various approaches, that are not listed herein but would be known to those of skill in the relevant art.

Moreover, each ACH recipient data file corresponds to at least one ACH recipient account. Each of the ACH recipient accounts are related to one or more electronic ACH transactions which may take place after the enterprise server sets up the ACH recipient accounts for future use. In one example, the ACH recipient accounts may be for employees of a business, and the electronic ACH transactions may be regular payroll distributions (or payments) to these employees. In another example, the ACH recipient accounts may be for a group of people that participated in and provided goods to sell at a garage sale, and the electronic ACH transactions may be a single payment to each person for the amount of their goods that sold at the garage sale.

According to one embodiment, the predefined file format may include a name field (for entry of a name associated with a particular account), a routing number field (for entry of a routing number for a financial institution associated with the particular account), an account number field (for entry of the account number that will be linked for ACH transactions), and an account type field (for entry of the type of account, e.g., checking, savings, general ledger (GL), loan, etc.).

In a further embodiment, the predefined file format may include an optional transaction amount field (for the selective entry of the amount of funds related to the ACH transaction for this account), and an optional note field (for selective entry of notes the user wishes to associate with the account and/or ACH transaction(s) for this account).

In one embodiment, the electronic ACH transaction may be a transfer of funds from an ACH originator account to a group of ACH recipient accounts. Further, the ACH originator account may be managed by the enterprise server and linked to the client device prior to or in response to receiving the ACH authentication request for preparing electronic ACH transactions to the group of ACH recipient accounts.

The electronic ACH transactions may be made directly after preparing the ACH recipient accounts in an approach, or may be triggered sometime in the future based on a triggering event in other approaches. Some examples of triggering events include, but are not limited to, payroll, completion of a task or assignment, a particular date or time being reached, expiration of a timer, etc.

In operation 206, the enterprise server deploys a trained generative artificial intelligence (GenAI) model. This trained GenAI model may be trained to perform a multitude of tasks related to the configuration of ACH transactions and ACH recipient accounts through the enterprise server.

In one embodiment, the GenAI model is configured to verify accuracy of data within the ACH recipient data files based on verification criteria provided to the GenAI model and/or learned by the GenAI model during training or deployment (updates).

According to a particular embodiment, the verification criteria includes decisions regarding specific aspects of the details included in the ACH recipient data files. In an example, the GenAI model may be configured to determine whether a set of details that are needed in order to process an ACH transaction have been provided within each of the ACH recipient data files. If any of the required details are lacking, the GenAI model may refrain from preparing the ACH recipient account associated with the particular ACH recipient data file.

In an embodiment, the set of details that are required to be provided with any ACH recipient data file may include, but are not limited to, an account number, a full name associated with the account number, a routing number associated with the account number, and an account type associated with the account number. Additional details may be included within the ACH recipient data file(s), such as date/timestamp, amount of funds related to one or more future or continuing transfers, notes associated with the ACH recipient account, a timeframe for which the recipient account is to remain active, etc.

In a further embodiment, the GenAI model is configured to generate details for the plurality of electronic ACH transactions. In this way, manual intervention is not needed to parse, understand, correct, store, and manage the details for each ACH recipient account (for which there may be tens, hundreds, thousands, or more), and errors are reduced in the process of preparing these accounts based on the refinement of the GenAI model.

According to an embodiment, the trained GenAI model may be configured to (e.g., trained to) recognize routing numbers and associated financial institutions from the ACH recipient data files. The trained GenAI model may parse, analyze, probe, discover, and/or evaluate the ACH recipient data files to individually determine routing numbers and identification of financial institutions from within the ACH recipient data files. In addition, the trained GenAI model may determine if any of the routing numbers and/or associated financial institutions are missing or are improperly or incorrectly entered.

In a further embodiment, the trained GenAI model may be configured to (e.g., trained to) determine whether each of the routing numbers discovered in the ACH recipient data files is properly associated with a corresponding financial institution (e.g., the proper financial institution that is linked to the particular routing number). This determination may be based on training of the GenAI model to recognize routing numbers from example ACH recipient data files, recognize financial institution details from example ACH recipient data files, and understand the links between financial institutions and specific routing numbers.

In operation 208, the enterprise server processes each of the requested electronic ACH transactions (which have been triggered and/or are to be processed directly after the recipient accounts are set up); however, the enterprise server will only process the electronic ACH transactions for which the accuracy of the data within a corresponding one of the ACH recipient data files is affirmatively verified.

In other words, the enterprise server will not process any ACH transactions for which the data provided to set up the corresponding ACH recipient account is incorrect, missing, corrupted, or otherwise unverifiable based on the GenAI model's analysis of the related ACH recipient data file(s).

According to one embodiment, the enterprise server may process each and every one of the electronic ACH transactions requested by the ACH authentication request only in response to affirmatively verifying the accuracy of the data within all of the one or more ACH recipient data files related to the electronic ACH transactions.

In one embodiment, a ML algorithm and/or AI algorithm may be employed to make certain determinations when performing computer-implemented method 200 alone or in conjunction with the GenAI model. This ML and/or AI algorithm may learn, update, and adjust based on execution conditions and system feedback (explicit or implicit) to determine how to optimize performance of computer-implemented method 200 and provide greater accuracy and efficiency when performing computer-implemented method 200. Moreover, the ML and/or AI algorithm may make better suggestions or recommendations to a user based on selections and/or curation by the ML and/or AI algorithm that are fine-tuned over time.

The ML and/or AI algorithm may be trained based on multiple training data sets. One training data set may include examples of correctly formatted ACH recipient data files, while another training data set may include examples of incorrectly formatted ACH recipient data files. In another example, a training data set may include examples of correctly formatted ACH authentication requests, while another training data set may include examples of incorrectly formatted ACH authentication requests. In yet another example, a training data set may include examples of correctly formatted electronic ACH transactions, while another training data set may include examples of incorrectly formatted electronic ACH transactions. By training the ML and/or AI algorithm on these various different aspects, the ML and/or AI algorithm will be configured to better perform method 200 and provide efficiency and accuracy to the process of preparing and executing a plurality of ACH transactions for a multitude of ACH recipient accounts.

Computer-implemented method 200 may be implemented in a system and/or a computer program product. For example, a system may include a processing circuit and logic integrated with the processing circuit, executable by the processing circuit, or integrated with and executable by the processing circuit. By integrated with, what is meant is that the processing circuit is a hardware processor that has hardcoded logic included therewith, such as an ASIC, a FPGA, etc. By executable by, what is meant is that the processing circuit is configured to execute software logic to achieve functionality dictated by the software logic. In this example, the logic is configured to cause the processing circuit to perform a portion or the entirety of computer-implemented method 200.

In another example, a computer program product may include a computer-readable storage medium having program instructions embodied therewith. The computer-readable storage medium may be any suitable storage device known in the art that is configured to store and allow processor(s) access to information and data stored therein. In this example, the embodied program instructions are executable by at least one processor to cause the at least one processor to perform a portion or the entirety of computer-implemented method 200.

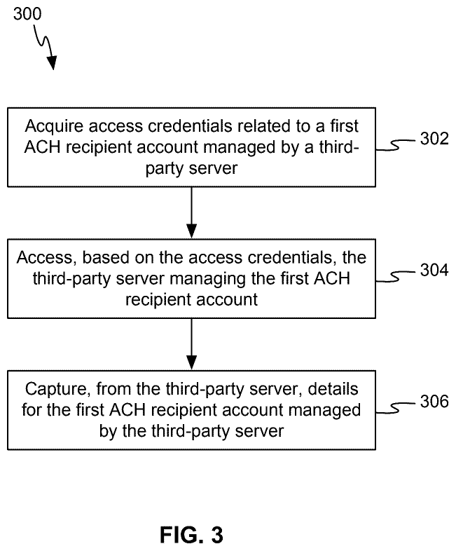

Referring now to FIG. 3, a flow chart of a computer-implemented method 300 for acquiring ACH recipient data file(s) is shown according to one embodiment. In an embodiment, computer-implemented method 300 may be executed in conjunction with any of the computer-implemented methods described in the other flowcharts, e.g., FIG. 2. Of course, more or less operations than those specifically described in FIG. 3 may be included in computer-implemented method 300, as would be understood by one of skill in the art upon reading the present descriptions.

Each of the operations of computer-implemented method 300 may be performed by any suitable component of the operating environment. For example, in various embodiments, computer-implemented method 300 may be partially or entirely performed by a cloud server, a portable computer, a handheld or wearable computer, a mobile device, one or more hardware processors of a computing device, an application operating on a computing device, a server device, a host device, a processing circuit having one or more processors therein, or some other device having one or more processors therein. The processing circuit, e.g., processor(s), chip(s), and/or module(s) implemented in hardware and/or software, and preferably having at least one hardware component, may be utilized in any device to perform one or more operations of computer-implemented method 300. Illustrative processors include, but are not limited to, a CPU, an ASIC, a FPGA, etc., combinations thereof, or any other suitable computing device known in the art.

In one embodiment, computer-implemented method 300 may be performed by an enterprise server that is configured to manage one or more accounts, particularly those capable of having ACH transactions executed therefor. Although computer-implemented method 300 is described as being performed by an enterprise server, any suitable computing device may be used, alone or in combination with other electronic devices, to perform computer-implemented method 300 in various embodiments.

In operation 302, the enterprise server acquires access credentials related to a first ACH recipient account managed by a third-party server. The access credentials may be sent to the enterprise server from the client device, the enterprise server may retrieve the access credentials directly or indirectly from the client device, or the enterprise server may obtain the access credentials directly or indirectly from the third-party server. The third-party server may be a financial server distinct from the enterprise server, a bank server, a brokerage server, or some other computing device that is related to or involved in financial transactions.

In one embodiment, the access credentials related to the first ACH recipient account may include, but are not limited to, a username and password combination for accessing a first ACH recipient account through an online portal managed by the third-party server. In a further embodiment, the access credentials related to the first ACH recipient account may include two-factor authentication details, that allow the enterprise server to navigate the two-factor authentication process through the third-party server, such as accessing a unique code provided to a user device via text message, email, or phone call.

In operation 304, the enterprise server accesses the third-party server managing the first ACH recipient account. This access is based on the access credentials acquired by the enterprise server, and the third-party server accepting those access credentials in order to grant access to the enterprise server to information and/or data that is protected by the access credentials (e.g., one or more financial accounts associated with the particular access credentials).

In operation 306, the enterprise server captures, from the third-party server, details for the first ACH recipient account managed by the third-party server. This process may be repeated for as many different accounts and different third-party servers that manage ACH recipient accounts involved in the ACH authentication request received in operation 202 of FIG. 2.

Referring again to FIG. 3, in one embodiment, a ML algorithm and/or AI algorithm may be employed to make certain determinations when performing computer-implemented method 300 alone or in conjunction with the GenAI model. This ML and/or AI algorithm may learn, update, and adjust based on execution conditions and system feedback (explicit or implicit) to determine how to optimize performance of computer-implemented method 300 and provide greater accuracy and efficiency when performing computer-implemented method 300. Moreover, the ML and/or AI algorithm may make better suggestions or recommendations to a user based on selections and/or curation by the ML and/or AI algorithm that are fine-tuned over time.

The ML and/or AI algorithm may be trained based on multiple training data sets. One training data set may include examples of correctly formatted ACH recipient data files, while another training data set may include examples of incorrectly formatted ACH recipient data files. In another example, a training data set may include examples of correctly formatted ACH authentication requests, while another training data set may include examples of incorrectly formatted ACH authentication requests. In yet another example, a training data set may include examples of correctly formatted electronic ACH transactions, while another training data set may include examples of incorrectly formatted electronic ACH transactions. By training the ML and/or AI algorithm on these various different aspects, the ML and/or AI algorithm will be configured to better perform method 300 and provide efficiency and accuracy to the process of preparing and executing a plurality of ACH transactions for a multitude of ACH recipient accounts.

Referring again to FIG. 3, computer-implemented method 300 may be implemented in a system and/or a computer program product. For example, a system may include a processing circuit and logic integrated with the processing circuit, executable by the processing circuit, or integrated with and executable by the processing circuit. By integrated with, what is meant is that the processing circuit is a hardware processor that has hardcoded logic included therewith, such as an ASIC, a FPGA, etc. By executable by, what is meant is that the processing circuit is configured to execute software logic to achieve functionality dictated by the software logic. In this example, the logic is configured to cause the processing circuit to perform a portion or the entirety of computer-implemented method 300.

In another example, a computer program product may include a computer-readable storage medium having program instructions embodied therewith. The computer-readable storage medium may be any suitable storage device known in the art that is configured to store and allow processor(s) access to information and data stored therein. In this example, the embodied program instructions are executable by at least one processor to cause the at least one processor to perform a portion or the entirety of computer-implemented method 300.

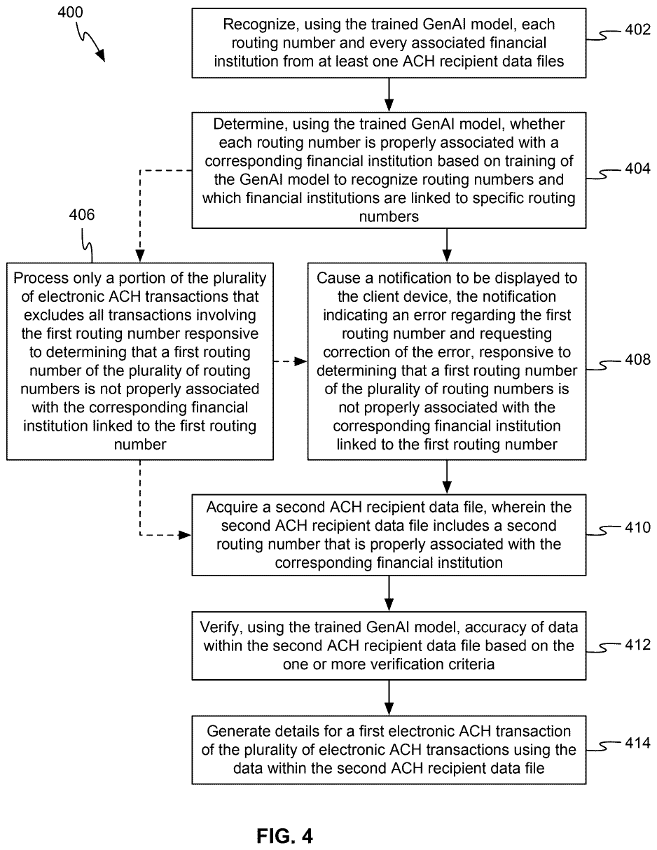

Referring now to FIG. 4, a flow chart of a computer-implemented method 400 for deploying a GenAI model is shown according to one embodiment. In an embodiment, computer-implemented method 400 may be executed in conjunction with any of the computer-implemented methods described in the other flowcharts, e.g., FIG. 2. Of course, more or less operations than those specifically described in FIG. 4 may be included in computer-implemented method 400, as would be understood by one of skill in the art upon reading the present descriptions.

Each of the operations of computer-implemented method 400 may be performed by any suitable component of the operating environment. For example, in various embodiments, computer-implemented method 400 may be partially or entirely performed by a cloud server, a portable computer, a handheld or wearable computer, a mobile device, one or more hardware processors of a computing device, an application operating on a computing device, a server device, a host device, a processing circuit having one or more processors therein, or some other device having one or more processors therein. The processing circuit, e.g., processor(s), chip(s), and/or module(s) implemented in hardware and/or software, and preferably having at least one hardware component, may be utilized in any device to perform one or more operations of computer-implemented method 400. Illustrative processors include, but are not limited to, a CPU, an ASIC, a FPGA, etc., combinations thereof, or any other suitable computing device known in the art.

In one embodiment, computer-implemented method 400 may be performed by an enterprise server that is configured to manage one or more accounts, particularly those capable of having ACH transactions executed therefor. Although computer-implemented method 400 is described as being performed by an enterprise server, any suitable computing device may be used, alone or in combination with other electronic devices, to perform computer-implemented method 400 in various embodiments.

In operation 402, the enterprise server, using the trained GenAI model, recognizes each routing number and every associated financial institution from at least one ACH recipient data file. This recognition is based on training of the GenAI model to recognize routing numbers from various different ACH recipient data files, allowing the GenAI model to learn how and where routing numbers may be positioned within an ACH recipient data file, along with what routing numbers look like and what various possible routing numbers may be presented in an ACH recipient data file (trained to recognize actual routing numbers and disregard words, phrases, gibberish, and numbers which cannot possibly be routing numbers).

The GenAI model is also trained to recognize which financial institutions are linked to specific routing numbers. For context, financial institutions (banks, brokerages, etc.) utilize specific routing numbers (and do not use other routing numbers, e.g., the routing numbers are assigned to the financial institution) for receiving deposits and payments from other financial institutions.

In operation 404, the enterprise server, using the trained GenAI model, determines whether each routing number is properly associated with a corresponding financial institution. This determination is based on training of the GenAI model to recognize routing numbers from the various ACH recipient data files, along with which financial institutions are linked to specific routing numbers. For context, financial institutions (banks, brokerages, etc.) utilize specific routing numbers (and do not use other routing numbers, e.g., the routing numbers are assigned to the financial institution) for receiving deposits and payments from other financial institutions. The GenAI model is trained on the specific routing numbers that financial institutions use (e.g., Wells Fargo® uses routing number 121000248 for domestic and international wire transfers, Truist® uses routing number 061000104 for most accounts, including checking and savings accounts, Charles Schwab® uses routing number 121202211 for its bank accounts, etc.).

In optional operation 406, according to one embodiment, responsive to determining that a first routing number of the plurality of routing numbers is not properly associated with the corresponding financial institution linked to the first routing number, the enterprise server may only process a portion of the plurality of electronic ACH transactions, the portion excluding all transactions involving the first routing number.

Upon conclusion of operation 406, the enterprise server may continue with operation 408 to generate a notification, or operation 410 to simply acquire a second ACH recipient data file, or simply end at this point after processing the portion of the plurality of electronic ACH transactions which excludes all transactions involving the first routing number (that was erroneous in some way).

In operation 408, the enterprise server causes a notification to be displayed to the client device. Operation 408 is performed responsive to determining that a first routing number of the plurality of routing numbers is not properly associated with the corresponding financial institution linked to the first routing number in an embodiment. The notification indicates that there is an error regarding the first routing number and requests correction of the error.

In this way, the user of the client device is apprised that one of the routing numbers appears to be incorrect, and the user is implored to correct the routing number (or correct the financial institution associated with the routing number) within a follow-up ACH recipient data file.

In an embodiment, the notification may indicate that the error can be corrected by either updating the routing number or updating the corresponding financial institution. This explicit information is intended to cause the user to make the necessary correction so that an ACH transaction associated with the erroneous routing number may be processed upon receiving the updated information.

In operation 410, the enterprise server acquires a second ACH recipient data file. The second ACH recipient data file includes a second routing number that is properly associated with the corresponding financial institution.

The second ACH recipient data file may be acquired in the same manner that the original ACH recipient data files were acquired in an embodiment. In one or more alternate embodiments, the second ACH recipient data file may be acquired through some other method, such as by the client device sending the second ACH recipient data file to the enterprise server, the enterprise server pulling the second ACH recipient data file from a data repository associated with the client device, the enterprise server generating the second ACH recipient data file based on recognizing an easily fixable error in the routing number, financial institution, or some other information needed to process the associated ACH transaction, etc.

In operation 412, the enterprise server, using the trained GenAI model, verifies accuracy of data within the second ACH recipient data file based on the one or more verification criteria. This is to ensure that the second ACH recipient data file has information included therein that is accurate and complete to allow for processing of an associated ACH transaction.

In operation 414, the enterprise server, using the trained GenAI model, generates details for a first electronic ACH transaction of the plurality of electronic ACH transactions using the data within the second ACH recipient data file. The first electronic ACH transaction relies on the information within the second ACH recipient data file, e.g., routing number, account number, financial institute, etc.

In one embodiment, a ML algorithm and/or AI algorithm may be employed to make certain determinations when performing computer-implemented method 400 alone or in conjunction with the GenAI model. This ML and/or AI algorithm may learn, update, and adjust based on execution conditions and system feedback (explicit or implicit) to determine how to optimize performance of computer-implemented method 400 and provide greater accuracy and efficiency when performing computer-implemented method 400. Moreover, the ML and/or AI algorithm may make better suggestions or recommendations to a user based on selections and/or curation by the ML and/or AI algorithm that are fine-tuned over time.

The ML and/or AI algorithm may be trained based on multiple training data sets. One training data set may include examples of correctly formatted ACH recipient data files, while another training data set may include examples of incorrectly formatted ACH recipient data files. In another example, a training data set may include examples of correctly formatted ACH authentication requests, while another training data set may include examples of incorrectly formatted ACH authentication requests. In yet another example, a training data set may include examples of correctly formatted electronic ACH transactions, while another training data set may include examples of incorrectly formatted electronic ACH transactions. By training the ML and/or AI algorithm on these various different aspects, the ML and/or AI algorithm will be configured to better perform method 400 and provide efficiency and accuracy to the process of preparing and executing a plurality of ACH transactions for a multitude of ACH recipient accounts.

Referring again to FIG. 4, computer-implemented method 400 may be implemented in a system and/or a computer program product. For example, a system may include a processing circuit and logic integrated with the processing circuit, executable by the processing circuit, or integrated with and executable by the processing circuit. By integrated with, what is meant is that the processing circuit is a hardware processor that has hardcoded logic included therewith, such as an ASIC, a FPGA, etc. By executable by, what is meant is that the processing circuit is configured to execute software logic to achieve functionality dictated by the software logic. In this example, the logic is configured to cause the processing circuit to perform a portion or the entirety of computer-implemented method 400.

In another example, a computer program product may include a computer-readable storage medium having program instructions embodied therewith. The computer-readable storage medium may be any suitable storage device known in the art that is configured to store and allow processor(s) access to information and data stored therein. In this example, the embodied program instructions are executable by at least one processor to cause the at least one processor to perform a portion or the entirety of computer-implemented method 400.

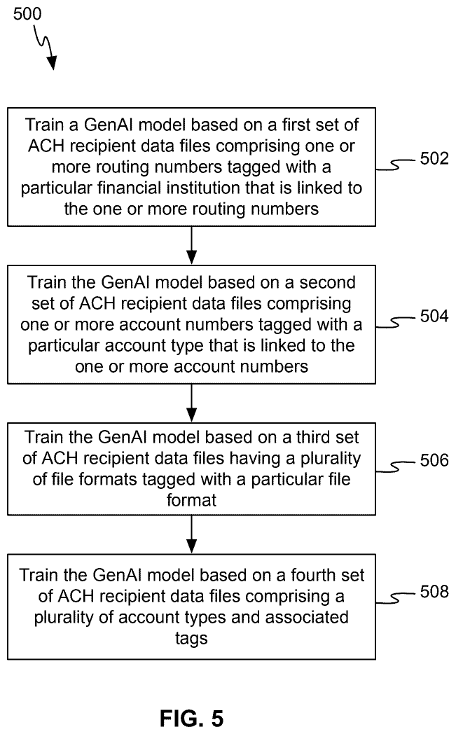

Referring now to FIG. 5, a flow chart of a computer-implemented method 500 for iteratively training a GenAI model is shown according to one embodiment. In an embodiment, computer-implemented method 500 may be executed in conjunction with any of the computer-implemented methods described in the other flowcharts, e.g., FIG. 2. Of course, more or less operations than those specifically described in FIG. 5 may be included in computer-implemented method 500, as would be understood by one of skill in the art upon reading the present descriptions.

Each of the operations of computer-implemented method 500 may be performed by any suitable component of the operating environment. For example, in various embodiments, computer-implemented method 500 may be partially or entirely performed by a cloud server, a portable computer, a handheld or wearable computer, a mobile device, one or more hardware processors of a computing device, an application operating on a computing device, a server device, a host device, a processing circuit having one or more processors therein, or some other device having one or more processors therein. The processing circuit, e.g., processor(s), chip(s), and/or module(s) implemented in hardware and/or software, and preferably having at least one hardware component, may be utilized in any device to perform one or more operations of computer-implemented method 500. Illustrative processors include, but are not limited to, a CPU, an ASIC, a FPGA, etc., combinations thereof, or any other suitable computing device known in the art.

In one embodiment, computer-implemented method 500 may be performed by an enterprise server that is configured to manage one or more accounts, particularly those capable of having ACH transactions executed therefor. Although computer-implemented method 500 is described as being performed by an enterprise server, any suitable computing device may be used, alone or in combination with other electronic devices, to perform computer-implemented method 500 in various embodiments.

In operation 502, the enterprise server trains a GenAI model based on a first set of training data. The GenAI model may be an initial, preliminary, or under-development GenAI model in one embodiment, and the training may take place prior to deploying the resulting trained GenAI model. In another embodiment, the GenAI model may already be established or trained, and operation 502 may be used to update or refine the GenAI model.

The first set of training data comprises a first set of ACH recipient data files. Each of the first set of ACH recipient data files includes one or more routing numbers tagged with a particular financial institution that is linked to the one or more routing numbers. By training the GenAI model with consecutive sets of ACH recipient data files that each include a particular financial institution linked to the routing numbers that are specific to that particular financial institution, the GenAI model learns which routing numbers are possible to be used by all the financial institutes for which ACH authorization requests may be received in the future.

The GenAI model may also be trained to recognize routing numbers from various different ACH recipient data files using the first set of training data, allowing the GenAI model to learn how and where routing numbers may be positioned within an ACH recipient data file, along with what routing numbers look like and what various possible routing numbers may be presented in an ACH recipient data file (trained to recognize actual routing numbers and disregard words, phrases, gibberish, and numbers which cannot possibly be routing numbers).

In a further embodiment, the trained GenAI model may be trained using additional sets of training data that include more routing numbers associated with their particular financial institutes as this new information comes available. For example, if a new financial institution starts business and is assigned or takes on a specific routing number or numbers, the trained GenAI model may be trained based on this set of training data to be able to associate these specific routing numbers with the new financial institution. In another example, if an established financial institute starts using new routing numbers or updates one of its existing routing numbers, the trained GenAI model may be trained based on this set of training data to be able to associate these new routing numbers with the established financial institution.

In operation 504, the enterprise server trains the GenAI model based on a second set of training data. The GenAI model may be an initial, preliminary, or under-development GenAI model in one embodiment, and the training may take place prior to deploying the resulting trained GenAI model. In another embodiment, the GenAI model may already be established or trained, and operation 504 may be used to update or refine the GenAI model.

The second set of training data comprises a second set of ACH recipient data files that include one or more account numbers tagged with a particular account type that is linked to the one or more account numbers. Each financial institute may use specific account number formats, may have specific combinations of digits within its account numbers, and/or may use different account number structures for different account types and/or for different financial institutions. For example, Mastercard® account numbers start with a different set of four digits as compared to Visa® account numbers.

The training of the GenAI model using the second set of training data teaches the GenAI model how to recognize account numbers from the ACH recipient data files, what accounts may be indicated by the different account numbers, and whether a particular financial institution is linked to an account number based on the structure or content of particular account numbers from various different ACH recipient data files.

In operation 506, the enterprise server trains the GenAI model based on a third set of training data. The GenAI model may be an initial, preliminary, or under-development GenAI model in one embodiment, and the training may take place prior to deploying the resulting trained GenAI model. In another embodiment, the GenAI model may already be established or trained, and operation 506 may be used to update or refine the GenAI model.

The third set of training data comprises a third set of ACH recipient data files that have a plurality of file formats, each ACH recipient data file being tagged with a particular file format in accordance with the type of file format it is. The third set of training data may include the following file formats, at a minimum: .pdf, .doc, .docx, .csv, .xls, and .xlsx. Each of these file formats have different structures, metadata, and associated applications, and the training based on the third set of training data teaches the GenAI model how to recognize the type of file that is being provided, such that the file can be properly parsed to retrieve the relevant data therefrom for formulating electronic ACH transaction(s).

In a further embodiment, the GenAI model may be trained to recognize specific locations, within each of the various file types on which it is trained, where different information and/or data will be placed or stored. For example, a Microsoft® Excel file may store a table of contents (e.g., in metadata) that provides an efficient way to recognize how many different individual accounts are included in the ACH recipient data file. In another example, an Adobe®. pdf file may include bookmarks within the file that designate where a next ACH recipient data set begins, and the previous ACH recipient data set ends.

Based on training with the third set of training data, the GenAI model is taught all the different file formats that are possible, along with how to recognize and process those file formats from the various different ACH recipient data files.

In operation 508, the enterprise server trains the GenAI model based on a fourth set of training data. The GenAI model may be an initial, preliminary, or under-development GenAI model in one embodiment, and the training may take place prior to deploying the resulting trained GenAI model. In another embodiment, the GenAI model may already be established or trained, and operation 508 may be used to update or refine the GenAI model.

The fourth set of training data comprises a fourth set of ACH recipient data files comprising a variety of account types and associated tags. The various account types may include checking accounts, savings accounts, GL accounts, loan accounts, mortgage accounts, brokerage accounts, etc. Each of these account types may have specific account numbers that will typically be associated therewith. The GenAI model may be trained based on these associations in an approach.

Based on training with the fourth set of training data, the GenAI model is taught all the different account types that are possible, along with how to recognize those account type designations within the various different ACH recipient data files.

In a further embodiment, the enterprise server may train the GenAI model based on a fifth set of training data. The GenAI model may be an initial, preliminary, or under-development GenAI model in one embodiment, and the training may take place prior to deploying the resulting trained GenAI model. In another embodiment, the GenAI model may already be established or trained, and this additional training may be used to update or refine the GenAI model.

In one or more embodiments, the additional training may be based on a set of training data that includes electronic ACH transactions having various different parameters, e.g., different account numbers, different routing numbers, different account types, different types of transactions (deposits, withdrawals, transfers, etc.), different monetary amounts, etc. Based on training using this additional set of training data, the GenAI model learns how to organize and formulate different types of electronic ACH transactions based on the details included in the various different ACH recipient data files.

In one embodiment, a ML algorithm and/or AI algorithm may be employed to make certain determinations when performing computer-implemented method 500 alone or in conjunction with the GenAI model. This ML and/or AI algorithm may learn, update, and adjust based on execution conditions and system feedback (explicit or implicit) to determine how to optimize performance of computer-implemented method 500 and provide greater accuracy and efficiency when performing computer-implemented method 500. Moreover, the ML and/or AI algorithm may make better suggestions or recommendations to a user based on selections and/or curation by the ML and/or AI algorithm that are fine-tuned over time.

The ML and/or AI algorithm may be trained based on multiple training data sets. One training data set may include examples of correctly formatted ACH recipient data files, while another training data set may include examples of incorrectly formatted ACH recipient data files. In another example, a training data set may include examples of correctly formatted ACH authentication requests, while another training data set may include examples of incorrectly formatted ACH authentication requests. In yet another example, a training data set may include examples of correctly formatted electronic ACH transactions, while another training data set may include examples of incorrectly formatted electronic ACH transactions. By training the ML and/or AI algorithm on these various different aspects, the ML and/or AI algorithm will be configured to better perform method 500 and provide efficiency and accuracy to the process of preparing and executing a plurality of ACH transactions for a multitude of ACH recipient accounts.

Referring again to FIG. 5, computer-implemented method 500 may be implemented in a system and/or a computer program product. For example, a system may include a processing circuit and logic integrated with the processing circuit, executable by the processing circuit, or integrated with and executable by the processing circuit. By integrated with, what is meant is that the processing circuit is a hardware processor that has hardcoded logic included therewith, such as an ASIC, a FPGA, etc. By executable by, what is meant is that the processing circuit is configured to execute software logic to achieve functionality dictated by the software logic. In this example, the logic is configured to cause the processing circuit to perform a portion or the entirety of computer-implemented method 500.

In another example, a computer program product may include a computer-readable storage medium having program instructions embodied therewith. The computer-readable storage medium may be any suitable storage device known in the art that is configured to store and allow processor(s) access to information and data stored therein. In this example, the embodied program instructions are executable by at least one processor to cause the at least one processor to perform a portion or the entirety of computer-implemented method 500.

### TECHNICAL ADVANTAGES

The techniques for managing ACH transactions that are described herein in accordance with multiple embodiments offer significant technical advantages over conventional techniques by incorporating a GenAI model trained on specific data to verify the accuracy of ACH recipient data files. This automated verification process ensures that each source file is checked against established verification criteria without requiring manual intervention. This approach reduces the likelihood of errors and discrepancies in the ACH transaction process, thereby enhancing the overall reliability and security of fund transfers. By automating the verification step, the need for manual intervention is minimized, leading to more efficient and faster processing times. Additionally, the use of a variety of file formats accommodates different data input methods, providing flexibility and ease of use for clients submitting ACH transaction requests. These features collectively streamline the ACH transaction process, improving operational efficiency and reducing costs for businesses and financial institutions.

### EXAMPLE SYSTEM ARCHITECTURE

According to one embodiment, the techniques described herein are implemented by one or more special-purpose computing devices (i.e., computing devices specially configured to perform certain functionality). The special-purpose computing devices may be hard-wired to perform the techniques, or may include digital electronic devices such as one or more ASICs, FPGAs, or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

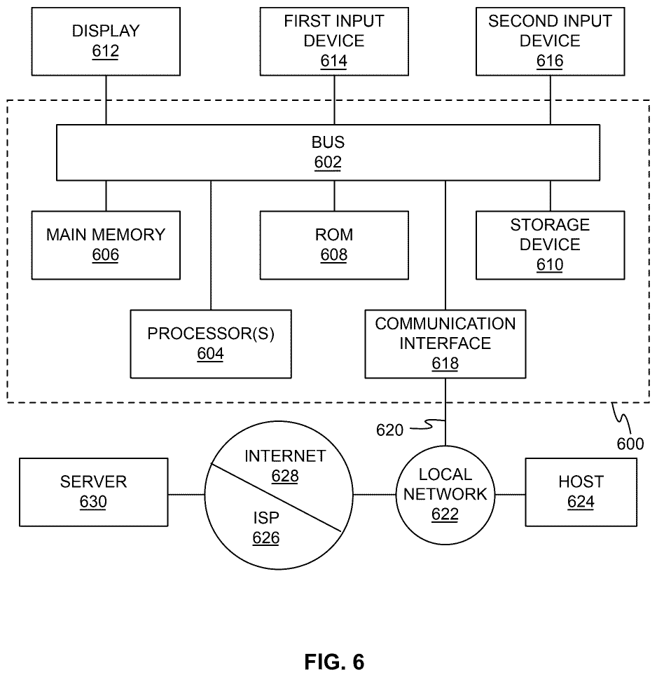

For example, FIG. 6 is a block diagram that illustrates a computer system 600 upon which an embodiment of the present disclosure may be implemented. Computer system 600 may be any type of system known in the art, such as a mobile device (smartphone, tablet, laptop, etc.), desktop computer, server, appliance, etc. As an option, computer system 600 may be implemented in conjunction with features from any other embodiments listed herein, such as those described with reference to any of FIGS. 1-5. Referring again to FIG. 6, computer system 600 includes a bus 602 or other communication mechanism for communicating information, and one or more hardware processors 604 coupled with bus 602 for processing information. The hardware processor(s) 604 may be of any type, for example, a general-purpose microprocessor, a central processing unit (CPU), a graphics processing unit (GPU), a microcontroller, etc.

Computer system 600 also includes a main memory 606 coupled to bus 602 for storing information and instructions to be executed by the processor(s) 604. Main memory 606 stores an operating system (OS). The OS includes instructions for handling basic system services and for performing hardware dependent tasks. Main memory 606 may additionally include instructions that cause computer system 600 to perform processes of the various embodiments described herein. In some embodiments, these instructions may be a subset of the OS or may be part of the instructions for an application.

In some embodiments, main memory 606 also may be used for storing temporary variables or other intermediate information during execution of instructions to be executed by processor(s) 604. Such instructions, when stored in non-transitory storage media accessible to processor(s) 604, render computer system 600 into a special-purpose machine that is customized to perform the operations specified in the instructions. In some embodiments, main memory 606 may include volatile memory (e.g., high-speed random access memory), non-volatile memory (e.g., flash memory), a combination of volatile and non-volatile memory, and/or any other type of memory.

Main memory 606 may also include instructions for controlling other aspects of computer system 600, such as communication instructions to facilitate communicating with one or more additional devices (e.g., for peer-to-peer data sharing, to connect to a server through the Internet for cloud-based data sharing, etc.); graphical user interface (GUI) instructions to facilitate GUI processing; image processing instructions to facilitate image-related processing and functions; input processing instructions to facilitate input-related processes and functions (e.g., mouse cursor, touch input, etc.); audio processing instructions to facilitate audio-related processes and functions; and camera instructions to facilitate camera-related processes and functions, etc. The instructions described above are merely exemplary and main memory 606 may include additional and/or other instructions in some embodiments. The above-identified instructions need not be implemented as separate software programs or modules. Various functions of computer system 600 may be implemented in hardware and/or in software, including in one or more signal processing and/or application specific integrated circuits.

Computer system 600 may further include a read only memory (ROM) 608 or other static storage device coupled to bus 602 for storing static information and instructions for processor(s) 604. ROM 608 may include any type of storage known in the art, such as a programmable read-only memory (PROM), erasable PROM (EPROM), a FLASH-EPROM, etc. A storage device 610, such as a magnetic disk, optical drive, or solid-state disk, is provided and coupled to bus 602 for storing information and instructions. Storage device 610 may include additional memory suitable for short term storage prior to writing to the storage device 610, such as non-volatile random-access memory (NVRAM), any other memory chip or cartridge, content-addressable memory (CAM), ternary content-addressable memory (TCAM), etc.

Computer system 600 may be coupled via bus 602 to a display 612, such as a liquid crystal display (LCD), light emitting diode (LED) display, touchscreen display, electronic ink display, cathode ray tube (CRT) monitor, or any other kind of device for displaying information to a user. A first input device 614, such as a keyboard or virtual keyboard that provides for selection of alphanumeric and/or other characters, may be coupled to bus 602 for communicating information and command selections to processor 604.

Alternatively, or in addition, computer system 600 may receive user input via a second input device 616, such as a mouse, a trackball, a trackpad, a touchscreen, a slider, and/or cursor direction keys. The second input device 616 may be configured for providing direction information, communicating command selections to processor 604, controlling cursor movement on display 612, etc. The second input device 616 may have at least two degrees of freedom in two axes, a first axis (e.g., x) and a second axis (e.g., y), that allows the second input device 616 to specify positions in a plane. The display 612 may be configured to receive user input via one or more pressure-sensitive sensors, multi-touch sensors, and/or gesture sensors. Alternatively, or in addition, computer system 600 may receive user input via a microphone, video camera, and/or some other kind of user input device (not shown).

Computer system 600 may implement the techniques described herein using customized hard-wired logic, one or more ASICs or FPGAs, firmware, and/or program logic which in combination with the computer system causes, configures, or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein in various embodiments. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, solid-state or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a programmable read-only memory (PROM), and erasable PROM (EPROM), a FLASH-EPROM, non-volatile random-access memory (NVRAM), any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio wave and infrared data communications.

Various forms of media may be involved in carrying one or more sequences of one or more instructions to processor(s) 604 for execution. For example, the instructions may initially be carried on a magnetic disk or solid-state drive of a remote computer. The remote computer can load the instructions into its dynamic memory and send the instructions over a network, via a network interface controller (NIC), such as an Ethernet controller or Wi-Fi controller. A NIC local to computer system 600 can receive the data from the network and place the data on bus 602. Bus 602 carries the data to main memory 606, from which processor(s) 604 retrieves and executes the instructions. The instructions received by main memory 606 may optionally be stored on storage device 610 either before or after execution by processor(s) 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a LAN card to provide a data communication connection to a compatible LAN. Wireless links may also be implemented. In any such implementation, communication interface 618 sends and receives electrical, electromagnetic, or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the worldwide packet data communication network commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618. The received code may be executed by processor(s) 604 as it is received, and/or stored in storage device 610, or other non-volatile storage for later execution.

One or more peripheral devices may be coupled to computer system 600, such as various sensors and subsystems. Some example peripheral devices include, but are not limited to, a camera subsystem, a wired communication subsystem, a wireless communication. subsystem, an audio subsystem, an I/O subsystem, etc. The peripheral devices may communicate with the processor(s) 604 directly through bus 602 or via a peripherals interface. In one example, an orientation sensor (e.g., a gyroscope) and an acceleration sensor (e.g., an accelerometer) may be coupled to the peripherals interface to facilitate orientation and acceleration functions for computer system 600.

In several examples, computer system 600 may include a camera subsystem that is coupled to one or more optical sensors (e.g., a charged coupled device (CCD) optical sensor, a complementary metal-oxide-semiconductor (CMOS) optical sensor, etc.). The optical sensors may facilitate camera functions, such as capturing image and/or video data. A wired communication subsystem and/or wireless communication subsystem may also be included to facilitate communication functions via one or more connections.

In some examples, computer system 600 may include a wireless communication subsystem having one or more radio frequency receivers and transmitters, optical receivers, and transmitters. These receivers and transmitters may be implemented to operate over one or more communication networks, such as a GSM network, a Wi-Fi network, a Bluetooth network, etc. An audio subsystem may be included in computer system 600, with the audio subsystem being coupled to a speaker or an output audio (e.g., to output music, voice navigation instructions, signals, etc.). Additionally or alternatively, the audio subsystem may be coupled to a microphone to facilitate audio input, such as voice-enabled functions in one example.

In an example, computer system 600 may include an I/O subsystem that is configured for managing transfer of data between input/output peripheral devices, such as a display, a touch screen, etc., and bus 602, e.g., via a peripherals interface. The I/O subsystem may include a touch-screen controller and/or other input controllers to facilitate the transfer between input/output peripheral devices and bus 602 of computer system 600. In this example, the touch-screen controller may be coupled to a touch screen for detecting contact and movement on the touch screen using any of multiple touch sensitivity technologies.

While the components illustrated in FIG. 6 are shown separately, one of ordinary skill in the art will recognize that two or more components may be integrated together, such as into one or more integrated circuits. In addition, two or more components may be coupled together by one or more communication buses or signal lines. Also, while many of the functions are described as being performed by a particular component, one of ordinary skill in the art will recognize that the functions described with respect to FIG. 6 may be split into multiple integrated circuits.

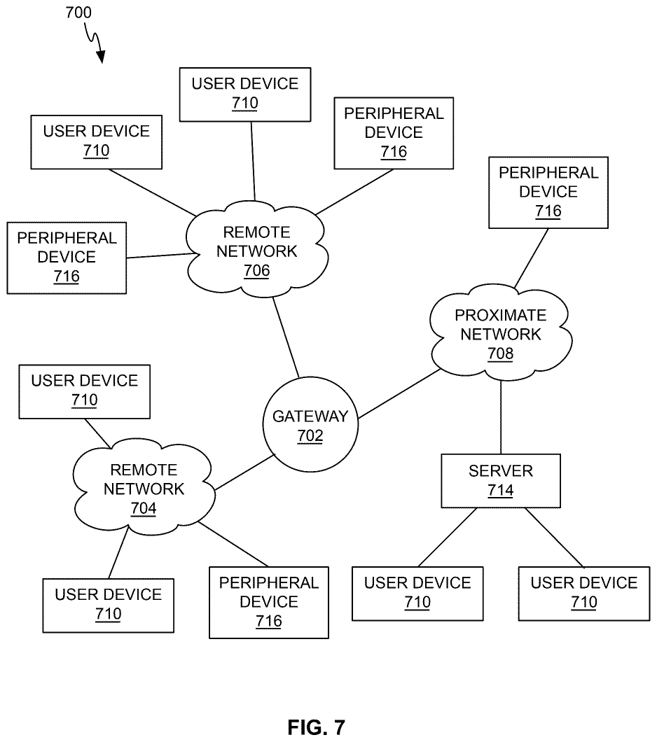

FIG. 7 illustrates a network architecture 700, in accordance with one or more embodiments. The computer system 600 of FIG. 6 may utilize any of the components described in network architecture 700 of FIG. 7, in various approaches. As an option, the present architecture 700 may be implemented in conjunction with features from any other embodiments listed herein, such as those described with reference to any of FIGS. 1-5. Of course, however, network architecture 700 of FIG. 7 and others presented herein may be used in various applications and/or in permutations which may or may not be specifically described in the illustrative embodiments listed herein. Further, network architecture 700 presented herein may be used in any desired environment.

One or more remote and/or proximate networks may be provided in network architecture 700. As shown in FIG. 7, network architecture 700 includes a first remote network 704 and a second remote network 706. A gateway 702 may be coupled between the remote networks 704, 706 and a proximate network 708. In the context of the present network architecture 700, the networks 704, 706, 708 may each take any form including, but not limited to, a LAN, a WAN such as the Internet, a storage area network (SAN), a public switched telephone network (PSTN), an internal telephone network, etc. Additional networks may also be connected via the gateway 702 or some other connection device known in the art. These networks may be of a different type than the networks 704, 706, 708. For example, a network may be devoted to the Internet of Things (IOT) and may provide infrastructure and protocols for communication between all devices in the IOT, and between any devices in the IOT and one or more of the other networks. In another example, a network may be devoted to Industrial control, and may provide infrastructure and protocols for communication within and/or between facilities anywhere in the world, including automated devices, manufacturing lines, assembly lines, processing control software, etc.

In use, the gateway 702 serves as an entrance point from the remote networks 704, 706 to the proximate network 708. As such, the gateway 702 may function as a router, configured to direct a given packet of data that arrives at the gateway 702, and a switch, which furnishes the actual path in and out of the gateway 702 for a given packet. In some embodiments, router functionality and switching functionality may be embodied in one or more different or additional devices.

Further included in the network architecture 700 is at least one server 714 coupled to the proximate network 708, and which is accessible from the remote networks 704, 706 via the gateway 702. It should be noted that the server(s) 714 may include any type of computing device/groupware, and may be of any type of server, e.g., a data server, financial server, cloud server, etc. A plurality of user devices 712 may be coupled to any server 714. User devices 712 may include any device known by one of skill in the relevant art, such as a desktop computer, a laptop computer, a hand-held computer, a smartphone, a terminal, a port, a printer, an automated teller machine (ATM), a debit or credit card reader device, a point of sale (POS) device, or some other type or form of processing logic, etc. It should be noted that one or more user devices 710 may also be directly coupled to any of the remote networks 704, 706, in various embodiments.

A peripheral 716 or series of peripherals, e.g., scanners, printers, networked storage units, hard disk drives, wireless routers, ATM, debit or credit card reader device, POS device, etc., may be coupled to one or more of the networks 704, 706, 708. It should be noted that databases, servers, mainframes, and/or additional components may be utilized with and/or integrated into any type of network element coupled to the networks 704, 706, 708. In the context of the present descriptions, a network element may refer to any component of a network, system, device, and/or any device useable in a network.

According to some approaches, methods and systems described herein may be implemented with and/or utilized on virtual systems and/or systems which emulate one or more other systems, such as a UNIX® system which emulates a macOS® environment, a UNIX® system which virtually hosts a Microsoft Windows® environment, a Microsoft Windows® system which emulates a macOS® environment, etc. This virtualization and/or emulation may be enhanced using virtualization software, such as VMware ESX®, Microsoft Hyper-V®, Intel Simics®, etc., in some embodiments.

In more approaches, one or more of the networks 704, 706, 708 may represent a cluster of systems commonly referred to as a “cloud.” In a cloud or “cloud computing,” shared resources, such as processing power, peripherals, software, data processing, servers, storage, etc., are provided to any system that has access to the cloud and permission to access the specific resource, preferably in an on-demand relationship. This allows for access and distribution of services across many computing systems. Cloud computing typically involves an Internet or other high-speed connection (e.g., 5G, fiber optic, etc.) between the systems operating in the cloud, but other techniques of connecting the systems may also be used, as would be understood by one of skill in the relevant art.

Variations, modifications, alterations, alternative constructions, and equivalents of the examples and embodiments described herein are also possible, and the explicit description thereof in these descriptions is not required to provide those of skill in the relevant art with the ability to conceive of such variations, modifications, alterations, alternative constructions, and equivalents when reading the present descriptions.

The examples and embodiments described herein are not restricted to operation within certain specific data processing environments and instead are free to operate within a plurality of data processing environments described or known to those of skill in the relevant art. Additionally, although certain examples and flowcharts have been described using a particular series of transactions and steps, it should be apparent to those of skill in the art that this is not intended to be limiting. Although some flowcharts describe operations as a sequential process, many of the operations may be performed in parallel or concurrently. In addition, the order of the operations may be rearranged. A process may have additional steps not included in the relevant figure. Various features and aspects of the above-described examples and embodiments may be used individually or jointly.

Further, while certain examples and embodiments have been described using a particular combination of hardware and software, it should be recognized that other combinations of hardware and software are also possible. Certain examples and embodiments may be implemented only in hardware, or only in software, or using combinations thereof. The various processes described herein may be implemented on the same processor or different processors in any combination.

Specific details are provided in this description to provide a thorough understanding of the embodiments and examples. However, examples and embodiments may be practiced without these specific details. For example, well-known circuits, processes, algorithms, structures, and techniques have been shown without unnecessary detail to avoid obscuring the examples and embodiments described. This description provides embodiments and examples only, and is not intended to limit the scope, applicability, or configuration of the present disclosure. Rather, the preceding description of the embodiments and examples will provide those of skill in the art with an enabling depiction for implementing the present disclosure.

Devices that are described as in “communication” with each other or “coupled” to each other need not be in continuous communication with each other or in direct physical contact, unless expressly specified otherwise. On the contrary, such devices need only transmit to each other as necessary or desirable, and may actually refrain from exchanging data most of the time. For example, a machine in communication with or coupled with another machine via the Internet may not transmit data to the other machine for a long period of time (e.g. weeks at a time). In addition, devices that are in communication with or coupled with each other may communicate directly or indirectly through one or more intermediaries.

The terms “coupled,” “attached,” or “connected” may be used herein to refer to any type of relationship, direct or indirect, between the components in query, and may apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Those skilled in the art will appreciate from the foregoing description that the broad techniques of the exemplary embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

Devices that are described as in “communication” with each other or “coupled” to each other need not be in continuous communication with each other or in direct physical contact, unless expressly specified otherwise. On the contrary, such devices need only transmit to each other as necessary or desirable, and may actually refrain from exchanging data most of the time. For example, a machine in communication with or coupled with another machine via the Internet may not transmit data to the other machine for a long period of time (e.g. weeks at a time). In addition, devices that are in communication with or coupled with each other may communicate directly or indirectly through one or more intermediaries.

The terms “coupled,” “attached,” or “connected” may be used herein to refer to any type of relationship, direct or indirect, between the components in query, and may apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Those skilled in the art will appreciate from the foregoing description that the broad techniques of the exemplary embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. A computer-implemented method for managing automated clearing house (ACH) transaction processing, the computer-implemented method comprising:
receiving, by an enterprise server from a client device, an ACH authentication request for preparing a plurality of electronic ACH transactions;
acquiring, by the enterprise server, one or more ACH recipient data files having a predefined file format, each ACH recipient data file corresponding to at least one ACH recipient account related to one or more of the plurality of electronic ACH transactions;
deploying, by the enterprise server, a trained generative artificial intelligence (GenAI) model configured to:
verify accuracy of data within the one or more ACH recipient data files based on one or more verification criteria; and
generate details for the plurality of electronic ACH transactions; and
processing, by the enterprise server, each of the plurality of electronic ACH transactions for which the accuracy of the data within a corresponding one of the ACH recipient data files is affirmatively verified.

2. The computer-implemented method as recited in claim 1, wherein the predefined file format is selected from a group of file formats comprising: .pdf, .doc, .docx, .csv, .xls, and .xlsx.

3. The computer-implemented method as recited in claim 1, further comprising, prior to acquiring the one or more ACH recipient data files:
acquiring, by the enterprise server, ACH authentication credentials of the client device; and
authenticating, by the enterprise server, that the client device is authorized to conduct ACH transactions for an ACH originator account managed by the enterprise server based on the ACH authentication credentials.

4. The computer-implemented method as recited in claim 1, wherein the electronic ACH transaction is a transfer of funds from an ACH originator account to a plurality of ACH recipient accounts, and wherein the ACH originator account is managed by the enterprise server and linked to the client device.

5. The computer-implemented method as recited in claim 1, wherein the trained GenAI model is configured to:
recognize a plurality of routing numbers and a plurality of associated financial institutions from the one or more ACH recipient data files; and
determine whether each routing number of the plurality of routing numbers is properly associated with a corresponding financial institution based on training of the GenAI model to recognize routing numbers and which financial institutions are linked to specific routing numbers.

6. The computer-implemented method as recited in claim 5, further comprising, responsive to determining that a first routing number of the plurality of routing numbers is not properly associated with the corresponding financial institution linked to the first routing number:
causing, by the enterprise server, a notification to be displayed to the client device, the notification indicating an error regarding the first routing number and requesting correction of the error.

7. The computer-implemented method as recited in claim 6, wherein the notification indicates that the error can be corrected by either updating the routing number or updating the corresponding financial institution.

8. The computer-implemented method as recited in claim 6, further
comprising, responsive to determining that a first routing number of the plurality of routing numbers is not properly associated with the corresponding financial institution linked to the first routing number:
acquiring, by the enterprise server, a second ACH recipient data file, wherein the second ACH recipient data file includes a second routing number that is properly associated with the corresponding financial institution;
verifying, by the enterprise server using the trained GenAI model, accuracy of data within the second ACH recipient data file based on the one or more verification criteria; and
generating, by the enterprise server using the trained GenAI model, details for a first electronic ACH transaction of the plurality of electronic ACH transactions using the data within the second ACH recipient data file.

9. The computer-implemented method as recited in claim 5, wherein, responsive to determining that a first routing number of the plurality of routing numbers is not properly associated with the corresponding financial institution linked to the first routing number, the enterprise server only processes a portion of the plurality of electronic ACH transactions, the portion excluding all transactions involving the first routing number.

10. The computer-implemented method as recited in claim 1, wherein the predefined file format comprises:
a name field;
a routing number field;
an account number field; and
an account type field.

11. The computer-implemented method as recited in claim 10, wherein the predefined file format further comprises:
an optional transaction amount field; and
an optional note field.

12. The computer-implemented method as recited in claim 1, wherein the enterprise server acquires a first ACH recipient data file of the one or more ACH recipient data files by:
acquiring access credentials related to a first ACH recipient account managed by a third-party server;
accessing, based on the access credentials, the third-party server managing the first ACH recipient account; and
capturing, from the third-party server, details for the first ACH recipient account managed by the third-party server.

13. The computer-implemented method as recited in claim 10, wherein the access credentials related to the first ACH recipient account comprise a username and password combination for accessing the related to a first ACH recipient account through an online portal managed by the third-party server.

14. The computer-implemented method as recited in claim 13, wherein the access credentials related to the first ACH recipient account further comprise two-factor authentication details.

15. The computer-implemented method as recited in claim 1, wherein the enterprise server processes each of the plurality of electronic ACH transactions in response to affirmatively verifying the accuracy of the data within all of the one or more ACH recipient data files.

16. The computer-implemented method as recited in claim 1, further comprising, prior to deploying the trained GenAI model, iteratively training an initial GenAI model based on sets of training data to create the trained GenAI model, wherein the sets of training data comprise:
a first set of ACH recipient data files comprising one or more routing numbers tagged with a particular financial institution that is linked to the one or more routing numbers;
a second set of ACH recipient data files comprising one or more account numbers tagged with a particular account type that is linked to the one or more account numbers; and
a third set of ACH recipient data files having a plurality of file formats tagged with a particular file format.

17. The computer-implemented method as recited in claim 1, further comprising, prior to deploying the trained GenAI model, iteratively training an initial GenAI model based on sets of training data to create the trained GenAI model, wherein the sets of training data comprise:
a first set of ACH recipient data files comprising a plurality of routing numbers and associated tags;
a second set of ACH recipient data files comprising a plurality of account numbers and associated tags; and
a third set of ACH recipient data files comprising a plurality of account types and associated tags.

18. The computer-implemented method as recited in claim 1, wherein the one or more verification criteria comprise whether a set of details needed to process an ACH transaction have been provided within each of the one or more ACH recipient data files, the set of details comprising:
an account number;
a full name associated with the account number;
a routing number associated with the account number; and
an account type associated with the account number.

19. A system for managing automated clearing house (ACH) transaction processing, the system comprising:
at least one processor; and
a non-transitory computer-readable medium having instructions embodied therewith that, when executed by the at least one processor, cause the at least one processor to perform operations comprising:
receiving, by an enterprise server from a client device, an ACH authentication request for preparing a plurality of electronic ACH transactions;
acquiring, by the enterprise server, one or more ACH recipient data files having a predefined file format, each ACH recipient data file corresponding to at least one ACH recipient account related to one or more of the plurality of electronic ACH transactions;
deploying, by the enterprise server, a trained generative artificial intelligence (GenAI) model configured to:
verify accuracy of data within the one or more ACH recipient data files based on one or more verification criteria; and
generate details for the plurality of electronic ACH transactions; and
processing, by the enterprise server, each of the plurality of electronic ACH transactions for which the accuracy of the data within a corresponding one of the ACH recipient data files is affirmatively verified.

20. A computer program product for managing automated clearing house (ACH) transaction processing, the computer program product comprising a non-transitory computer-readable storage medium having program instructions embodied therewith that, when executed by the at least one processor, cause the at least one processor to perform operations comprising:
receiving, by an enterprise server from a client device, an ACH authentication request for preparing a plurality of electronic ACH transactions;
acquiring, by the enterprise server, one or more ACH recipient data files having a predefined file format, each ACH recipient data file corresponding to at least one ACH recipient account related to one or more of the plurality of electronic ACH transactions;
deploying, by the enterprise server, a trained generative artificial intelligence (GenAI) model configured to:
verify accuracy of data within the one or more ACH recipient data files based on one or more verification criteria; and
generate details for the plurality of electronic ACH transactions; and
processing, by the enterprise server, each of the plurality of electronic ACH transactions for which the accuracy of the data within a corresponding one of the ACH recipient data files is affirmatively verified.
